(19) United States
(12) Patent Application Publication
(10) Pub. No.: US 2008/0255759 A1
(43) Pub. Date: Oct. 16, 2008

(54) Travel arrangements through buddy lists in a geosocial environment

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/786,330

(22) Filed: Apr. 11, 2007

(51) Int. Cl. G01C 21/30

(52) U.S. Cl. 701/209; 709/206

(57) ABSTRACT

A method, apparatus and system of travel arrangement using buddy lists in a geosocial environment are disclosed. In one embodiment, a method includes providing a plurality of user profiles, each profile in the plurality of user profiles to include an associated specific geographic location, associating a user with a first user profile in the plurality of user profiles, selecting a second user profile in the plurality of user profiles, determining a mode of physical communication, and generating a physical communication plan of physical communication between a first specific geographic location associated with the first user profile in the plurality of user profiles and a second specific geographic location associated with the second user profile in the plurality of user profiles. The method may also include providing a plurality of modes of physical communication.

### FIELD OF TECHNOLOGY

This disclosure relates generally to the technical fields of communications and, in one example embodiment, to a method, apparatus, and system of travel arrangements through buddy lists in a geosocial environment.

### BACKGROUND

Connected parties (e.g., buddies) of a social network may form relationships within the social network. The relationships may involve communication within the social network (e.g., such as an email communication).

The relationships may also transcend the social network. The relationships may include communication outside of the social network. For example, the buddies may gather at a neighborhood party or may form a working relationship at a workplace. The buddies may travel by car or by plane to visit one another. One buddy may mail a package to another.

To communicate, one or all of the buddies may expend time and effort planning and gathering the information necessary to arrange communication outside the social network. For example, a buddy may decide to visit a friend in the social network that lives a distance away. The buddy may look up a friend's home address in a personal address book outside the social network. The buddy may then access a travel arrangement website separate from the social network and finalize travel arrangements to visit the friend. Finally, the buddy may seek out and access a mapping resource (e.g., a website) separate from the social network to obtain driving directions from a destination airport to the friend's home.

### SUMMARY

A method, system and apparatus of travel arrangements through buddy lists in a geosocial environment are disclosed. In one aspect, a method includes providing a plurality of user profiles, each user profile in the plurality of user profiles to include an associated specific geographic location, associating a user with a first user profile in the plurality of user profiles, selecting a second user profile in the plurality of user profiles, determining a mode of physical communication, and generating a physical communication plan (e.g., the physical communication plan may be based on the determined mode of physical communication) of physical communication between a first specific geographic location associated with the first user profile in the plurality of user profiles and a second specific geographic location associated with the second user profile in the plurality of user profiles.

In addition, the method may include providing a plurality of modes of physical communication, and selecting at least one mode of physical communication in the plurality of modes of physical communication (e.g., the physical communication plan may be based on the at least one mode of physical communication in the plurality of modes of physical communication). The method may also include determining a threshold distance parameter, calculating a distance between the first specific geographic location associated with the first user profile in the plurality of user profiles and the second specific geographic location associated with the second user profile in the plurality of user profiles, comparing the threshold distance parameter and the calculated distance between the first specific geographic location associated with the first user profile in the plurality of user profiles and the second specific geographic location associated with the second user profile in the plurality of user profiles to determine a comparison result, and determining the mode of physical communication based on the comparison result.

Furthermore, the method may include providing physical communication options based on the mode of physical communication, selecting a physical communication option of the physical communication options, and generating the physical communication plan based on the selected physical communication option of the physical communication options. The method may also include communicating a message relevant to the physical communication plan to at least one recipient.

In another aspect, a system includes an integrated geosocial environment, a social network module of the integrated geosocial environment, the social network module to include user profiles, each user profile of the user profiles to include an associated specific geographic location. The system also includes a map module to include map data of the specific geographic locations of each user profile of the user profiles, the map data to serve as a basis to determine physical communication plans and/or to render maps modeling at least two orthogonal directions to indicate at least one specific geographic location associated with a selected user profile of the user profiles. The system further includes a selection module to select a second user profile of the user profiles, a mode determination module to determine a mode of physical communication, and a plan module to generate a physical communication plan to detail a physical communication between a first specific geographic location associated with a first user profile and a second specific geographic location associated with the second user profile.

The system may yet include a profile add module to add a user profile to the user profiles and/or to modify the user profile of the user profiles. Also, the system may include a display module to display a plurality of modes of physical communication associated with the second user profile and/or to select a mode of physical communication in the plurality of modes of physical communication associated with the second user profile.

Furthermore, the system may include a travel arrangement module to include travel planning data to use as a basis to generate the physical communication plan. Moreover, the system may include a surface travel module to include route data to use as a basis to generate surface travel instructions included in the physical communication plan and an air travel module to include air travel data to use as a basis to generate an air travel itinerary and reservations included in the physical communication plan.

The system may also include a rental car module to include rental car data to use as a basis to generate a rental car reservation included in the physical communication plan, a travel package module to include data related to combined modes of transportation to use as a basis to generate a travel package included in the physical communication plan and a mail module to include mail data to use as a basis to generate printable postage labels and printable address labels included in the physical communication plan.

In yet another aspect, an integrated geosocial environment includes a first instruction set to enable a social network, to include a people database, a businesses database, and a places database, each of the people database, the businesses database, and the places database to include associated user profiles, the social network associated with global map data, in which the social network is associated with specific geographic locations identifiable in the global map data, a second instruction set integrated with the first instruction set to select a user profile of the user profiles, the user profile to include an associated specific geographic location identifiable in the global map data, and a third instruction set integrated with the first instruction set and the second instruction set to generate a physical communication plan between a predetermined geographic location and the specific geographic location associated with the selected user profile.

The integrated geosocial environment may also include a fourth instruction set to provide a plurality of modes of physical communication (e.g., the physical communication plan is at least partially derived from at least one mode of physical communication in the plurality of modes of physical communication) and to determine at least one mode of physical communication of the plurality of modes of physical communication. Furthermore, the integrated geosocial environment may include a fifth instruction set to determine a threshold distance parameter and to calculate a distance between the predetermined geographic location and a specific geographic location associated with the selected user profile, and to compare the threshold distance parameter and the calculated distance to determine a mode of physical communication based on the comparison.

In addition, the integrated geosocial environment may include a sixth instruction set to provide options related to a mode of physical communication and to select at least one option of the options related to the mode of physical communication, and a seventh instruction set to provide information about the physical communication plan to at least one recipient.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of an integrated geosocial environment communicating with users through a network, according to one embodiment.

FIG. 2 is an exploded view of the social network module of the integrated geosocial environment of FIG. 1, according to one embodiment.

FIG. 3 is an exploded view of additional modules of FIG. 1, according to one embodiment.

FIG. 4 is a user interface view showing a user profile associated with a specific geographic location in the integrated geosocial environment, according to one embodiment.

FIG. 5 is a display view of a buddy list of the user associated with the first profile, according to one embodiment.

FIG. 6 is a mode determination view for the user associated with the first user profile using the buddy list, according to one embodiment.

FIG. 7 is a physical communication plan of the user associated with the first user profile, according to one embodiment.

FIG. 8 is a diagrammatic system view of a data processing system in which any of the embodiments disclosed herein may be performed, according to one embodiment.

FIG. 9 is a table view of a user travel plan, according to one embodiment.

FIG. 10A is a process flow of generating a physical communication plan in an integrated geosocial environment, according to one embodiment.

FIG. 10B is a continuation of the process flow of FIG. 10A, illustrating additional processes, according to one embodiment.

### Other features of the present embodiments will be apparent from the accompanying drawings and from the detailed description that follows.

### DETAILED DESCRIPTION

A method, apparatus and system of travel arrangements through buddy lists in a geosocial environment are disclosed. In the following description, for the purposes of explanation, numerous specific details are set forth in order to provide a thorough understanding of the various embodiments. It will be evident, however, to one skilled in the art that the various embodiments may be practiced without these specific details.

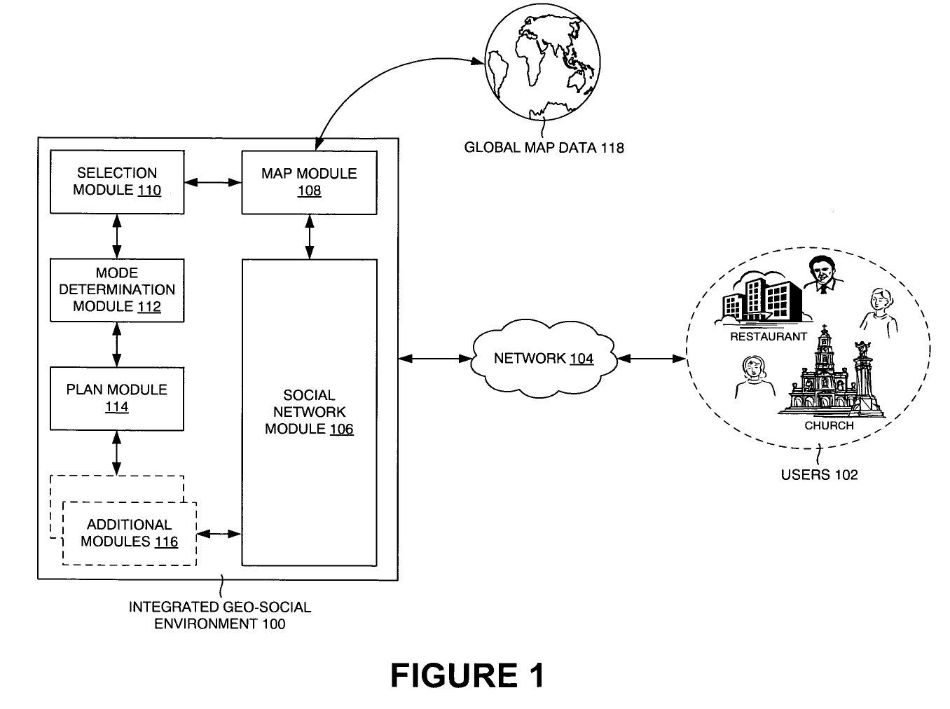

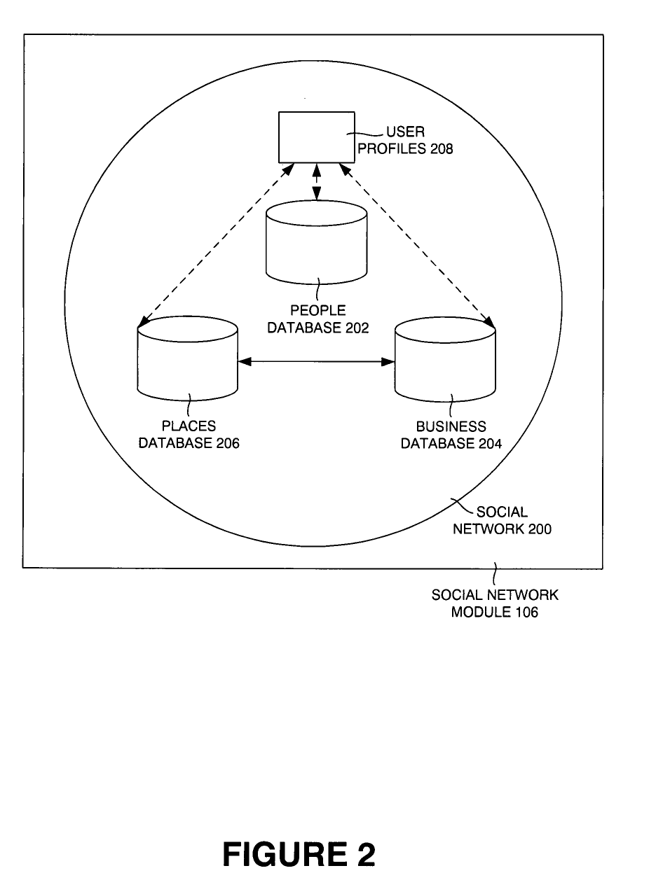

In one embodiment, a method includes providing user profiles (e.g., the user profiles 208 of FIG. 2), each user profile 208 to include an associated specific geographic location. The method may also include associating a user (e.g., the user 102 of FIG. 1) with a first user profile 208, selecting a second user profile 208, determining a mode of physical communication, and/or generating a physical communication plan (e.g., the physical communication plan may be based on the determined mode of physical communication) of physical communication between a first specific geographic location associated with the first user profile 208 and a second specific geographic location associated with the second user profile 208.

In another embodiment, a system includes an integrated geosocial environment (e.g., the integrated geosocial environment 100 of FIG. 1) and a social network module (e.g., the social network module 106 of FIG. 1) of the integrated geosocial environment 100. The social network module 100 may include user profiles 208 (e.g., each user profile may include an associated specific geographic location). The system also includes a map module (e.g., the map module 108 of FIG. 1) to include map data of the specific geographic locations of each user profile 208 (e.g., the map data to serve as a basis to determine physical communication plans and to render maps modeling at least two orthogonal directions to indicate at least one specific geographic location associated with a selected user profile 208), a selection module (e.g., the selection module 110 of FIG. 1) to select a second user profile 208, a mode determination module (e.g., the mode determination module 112 of FIG. 1) to determine a mode of physical communication, and a plan module (e.g., the plan module 114 of FIG. 1) to generate a physical communication plan to detail a physical communication between a first specific geographic location associated with the first user profile 208 and a second specific geographic location associated with the second user profile 208.

In yet another embodiment, an integrated geosocial environment (e.g., the integrated geosocial environment 100 of FIG. 1) includes a first instruction set to enable a social network to include a people database, a businesses database, and a places database (e.g., each of the people database, the businesses database, and the places database to include associated user profiles 208), the social network associated with global map data (e.g., in which the social network is associated with specific geographic locations identifiable in the global map data), a second instruction set integrated with the first instruction set to select a user profile 208, (e.g., the user profile 208 to include an associated specific geographic location identifiable in the global map data), and a third instruction set integrated with the first instruction set and the second instruction set to generate a physical communication plan between a predetermined geographic location and the specific geographic location associated with the selected user profile 208.

FIG. 1 is a system view of an integrated geosocial environment 100 communicating with users 102 through a network 104, according to one embodiment. Particularly, FIG. 1 illustrates the integrated geosocial environment 100, the users 102, the network 104, a social network module 106, a map module 108, a selection module 110, a mode determination module 112, a plan module 114, additional modules 116 and global map data 118, according to one embodiment.

The integrated geosocial environment 100 may enable the users 102 to communicate with the social network 106 (e.g., through a buddy list). The users 102 may be registered and/or unregistered users communicating in the integrated geosocial environment 100. The network 104 may be the social networks, professional networks and/or business networks that enable the users 102 to communicate in the geosocial environment 100. The social network module 106 may include various user profiles (e.g., the user profiles 208 of FIG. 2) with specific geographic locations associated with each user profile 208 in the integrated geosocial environment 100. The map module 108 may process (e.g., represent, generate and/or render in various forms) maps and/or visualizations in the integrated geosocial environment 100.

The selection module 110 may process a selection of profiles from the buddy lists (e.g., of friends, businesses, and/or people) of users 102 to communicate physically in the integrated geosocial environment 100. The mode determination module 112 may determine a travel mode for the users 102 to physically communicate in the integrated geosocial environment 100. The plan module 114 may detail a physical communication plan to enable users 102 to physically communicate in the geosocial environment 100. The additional modules 116 may generate different options associated with the physical communication plan for the users 102 to communicate with each other. The global map data 118 may contain details or maps of any area, region and/or neighborhood.

In the example embodiment illustrated in FIG. 1, the users 102 communicate with the social network module 106 through the network 104. Also, the integrated geosocial environment 100 consists of the social network module 106, the map module 108, the selection module 110, the mode determination module 112, the plan module 114, and the additional modules 116 communicating with each other, according to the example embodiment illustrated in FIG. 1.

A user 102 may be associated with a first user profile 208 and/or a second user profile 208 may be selected. A mode of physical communication may be determined (e.g., by air, by car, by rail, by public transport, by postal mail, by courier, etc.) and/or a physical communication plan of (e.g., based on the determined mode of physical communication) between a first specific geographic location associated with the first user profile 208 and a second specific geographic location associated with the second user profile 208 may be generated.

The social network module 106 of the integrated geosocial environment 100 may include user profiles 208 (e.g., each user profile 208 may include an associated specific geographic location). The map module 108 may include map data of the specific geographic locations of the user profiles 208. For example, the map data may serve as a basis to determine physical communication plans (e.g., travel plans) and/or as a basis to render maps modeling at least two orthogonal directions to indicate at least one specific geographic location associated with a selected user profile 208. The selection module 110 may select the second user profile 208 (e.g., associated with the second specific geographic location).

The mode determination module 112 may determine a mode of physical communication (e.g., of travel). The plan module 114 may generate a physical communication plan (e.g., a travel plan) to detail a physical communication between a first specific geographic location associated with a first user profile 208 and a second specific geographic location associated with the second user profile 208. The third instruction set integrated with the first instruction set and the second instruction set may generate a physical communication plan between a predetermined geographic location and the specific geographic location associated with the selected user profile 208.

A fourth instruction set may provide a plurality of modes of physical communication and/or determine the mode of physical communication from the plurality of modes of physical communication (e.g., the physical communication plan may be at least partially derived from the determined mode of physical communication).

FIG. 2 is an exploded view of the social network module 106 of the integrated geosocial environment 100 of FIG. 1, according to one embodiment. Particularly, FIG. 2 illustrates a social network 200, a people database 202, a businesses database 204, a places database 206 and user profiles 208, according to one embodiment.

The social network 200 may be a network of the people, places and/or businesses in the integrated geosocial environment 100. The people database 202 may contain the profiles of the users (e.g., the users 102 of FIG. 1) in the social network 200. The businesses database 204 may store and/or reference details of people and/or businesses in the social network 200. The places database 206 may contain location and/or people details (e.g., associated with profiles in the integrated geosocial environment 100) which the users 102 may use to communicate with (e.g., and/or travel to/from) the locations and/or people. The user profiles 208 may generate user profiles 208 which are associated with the specific geographic location in the integrated geosocial environment 100.

In the example embodiment illustrated in FIG. 2, the social network module 106 includes the social network 200. The social network 200 consists of the people database 202, the businesses database 204, the places database 206 communicating with and the user profile 208, according to the example embodiment illustrated in FIG. 2.

A plurality of user profiles 208 may be provided, and/or each user profile 208 may include an associated specific geographic location (e.g., representing a location of the user profile 208 in the integrated geosocial environment 100). A first instruction set (e.g., an algorithm, a command, a program, software code, etc.) may enable a social network, and/or may include a people database, a businesses database, and a places database. The people database, the businesses database, and/or the places database may include associated user profiles 208. The social network may also be associated with the global map data, in which the social network is associated with specific geographic locations identifiable in the global map data (e.g., using the map module 108 of FIG. 1). A second instruction set integrated with the first instruction set may select a user profile 208 (e.g., the user profile 208 may include an associated specific geographic location identifiable in the global map data).

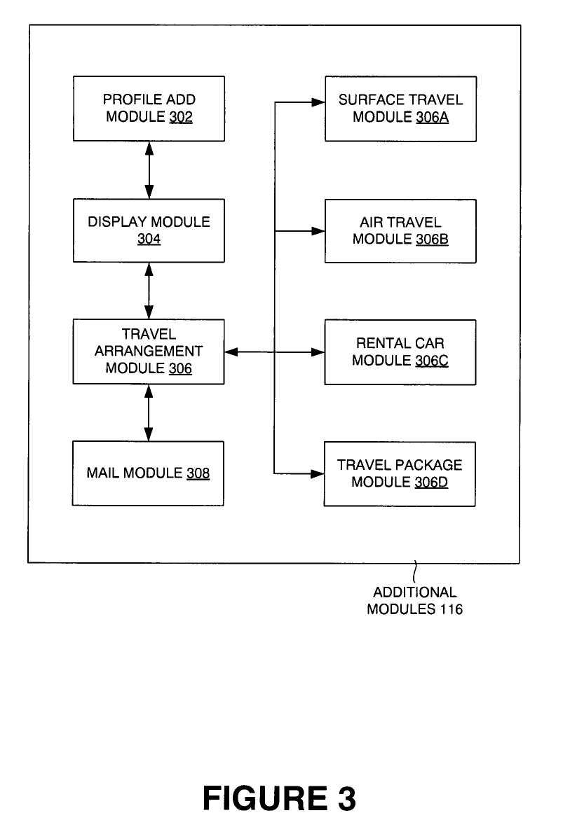

FIG. 3 is an exploded view of additional modules 116 of FIG. 1, according to one embodiment. Particularly, FIG. 3 illustrates a profile add module 302, a display module 304, a travel arrangement module 306, a surface travel module 306A, an air travel module 306B, a rental car module 306C, a travel package module 306D and a mail module 308, according to one embodiment.

The profile add module 302 may add and/or modify the user profiles 208 associated with specific geographic location(s) in the integrated geosocial environment 100. The display module 304 may display the different modes of physical communication available for the users in the integrated geosocial environment 100 to communicate with each other. The travel arrangement module 306 may generate travel plans when the users 102 of the integrated geosocial environment communicate physically with each other. The surface travel module 306A may provide path and/or direction details for the users to travel from one location to another in the integrated geosocial environment 100.

The air travel module 306B may generate air travel information (e.g., departure/arrival times and locations, tickets, transit routes, flight/carrier preferences, etc.) when the user 102 wants to travel to the destination associated with the selected user profile 208 by air. The rental car module 306C may generate details of a car rental plan (e.g., pickup/drop-off locations, rates, insurance packages, etc.) when the users 102 of the integrated geosocial environment 100 wish to travel by car to communicate with each other. The travel package module 306D may generate all details required by the users 102 to travel to the desired locations using any travel mode. The mail module 308 may facilitate correspondence to be made among the users 102 of the integrated geosocial environment 100, including, for example, mailing letters and packages.

In the example embodiment illustrated in FIG. 3, the profile add module 302 communicates with the display module 304. The travel arrangement module 306 communicates with the display module 304 and the mail module 308. Also, the travel arrangement module 306 communicates with the surface travel module 306A, the air travel module 306B, the rental car module 306C and the travel package module 306D communicate with each other, according to the example embodiment illustrated in FIG. 3.

The profile add module may add and/or modify a user profile 208. The display module 304 may display a plurality of modes of physical communication associated with the second user profile 208 and/or select the mode of physical communication associated with the second user profile 208. The travel arrangement module 306 may include travel planning data to use as a basis to generate the physical communication plan. The surface travel module 306A may include route data to use as a basis for and/or to generate surface travel instructions included in the physical communication plan.

The air travel module 306B may include air travel data to use as a basis for and/or to generate an air travel itinerary and/or reservations included in the physical communication plan. The rental car module 306C may include rental car data to use as a basis for and/or to generate a rental car reservation included in the physical communication plan. Furthermore, the mail module 308 may include mail data to use as a basis for and/or to generate mailing arrangements in the physical arrangement plan, including, for example, printable postage labels and printable address labels.

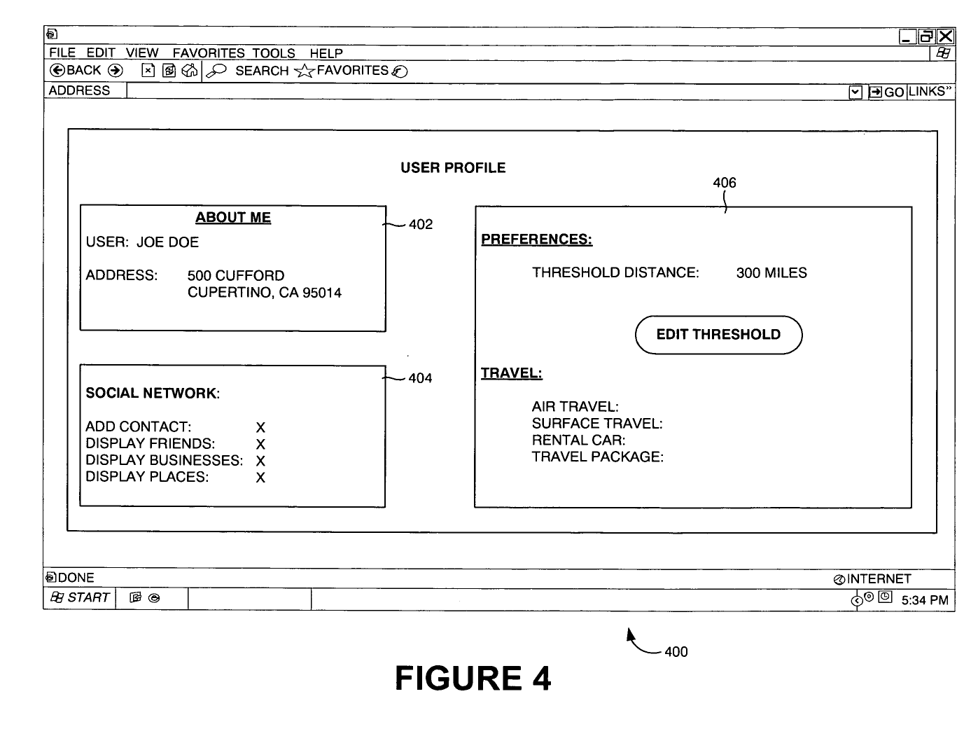

FIG. 4 is a user interface view showing a user profile 400 associated with a specific geographic location in the integrated geosocial environment 100, according to one embodiment. Particularly, FIG. 4 illustrates an about me label 402, a social network link 404 and a preferences label 406, according to one embodiment.

The about me label 402 may display details (e.g., name, address, etc.) of the user 102 associated with the first user profile 208 in the integrated geosocial environment (e.g., the integrated geosocial environment 100 of FIG. 1). The social network link 404 may provide details of contacts (e.g., friends, businesses, places, etc.) associated with the user 102. The preferences label 406 may display the user 102 preferences in traveling (e.g., using a buddy list).

The preferences label 406 may process a threshold distance the user 102 may set to determine which mode of physical communication to use. For example, the user 102 may set a threshold distance of 300 miles. If a distance between the user 102's specific geographic location and a specific geographic location of a selected user profile 208 is fewer than 300 miles, the mode of transportation may be set for surface travel. If the distance is greater than 300 miles, the mode of transportation may be set for air travel.

In the example embodiment illustrated in FIG. 4, the user interface view may enable the user to view profiles (e.g., user profiles 208 of the integrated geosocial environment 100) and/or their preferences, etc.

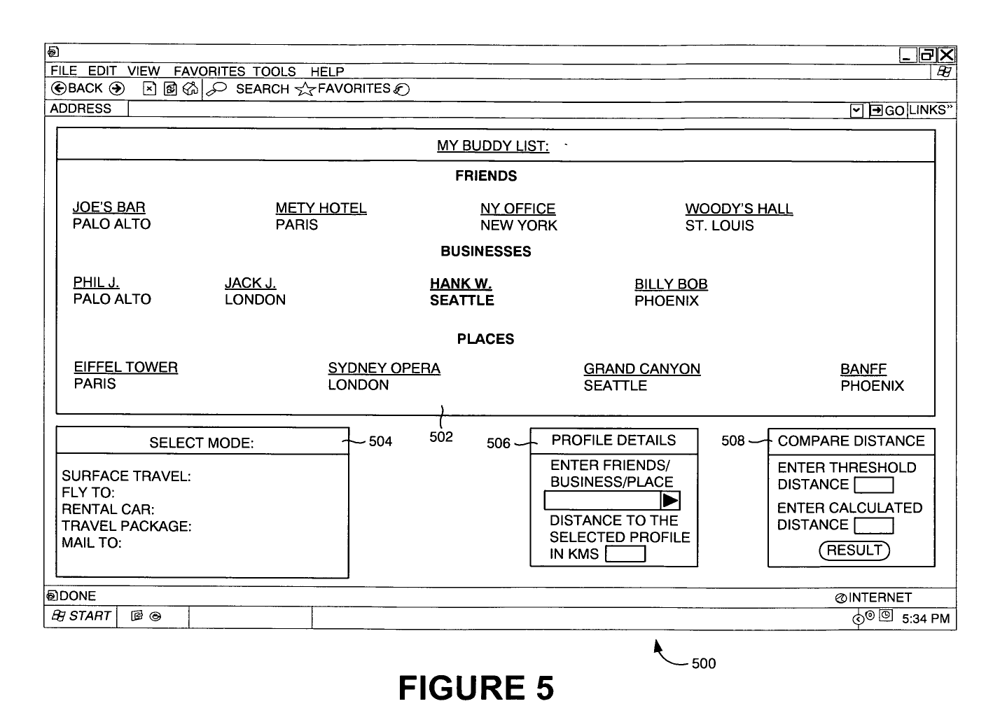

FIG. 5 is a display view 500 of a buddy list of the user 102 associated with the first user profile 208, according to one embodiment. Particularly, FIG. 5 illustrates a my buddy list link 502, a select mode link 504, a profile details option 506 and a compare distance option 508, according to one embodiment.

The my buddy list link 502 may display a list of buddies (e.g., friends, businesses, places and/or users 102 having an association with) of the user 102 with whom the first user profile 208 of the integrated geosocial environment (e.g., the integrated geosocial environment 100 of FIG. 1) is associated. The select mode link 504 may allow the user 102 to select and/or choose the travel mode to physically communicate with buddies of the buddy list (e.g., friends, businesses, places). The profile details option 506 may enable the user 102 to view the profile details of the friends, businesses and/or places and/or allow viewing a distance to selected profile(s) (e.g., of the buddies). The compare distance option 508 may enable the user 102 to compare the distance between the entered threshold distance and the calculated distance (e.g., by clicking on a result option in the display view).

In the example embodiment illustrated in FIG. 5, the display view may exhibit the buddy list of the user 102 associated with the first user profile 208 in the integrated geosocial environment 100 and the different modes by which the user 102 communicates with the buddy list.

The distance between the first specific geographic location associated with the first user profile 208 and the second specific geographic location associated with the second user profile 208 may be calculated. Also, a threshold distance parameter and the calculated distance between the first specific geographic location and the second specific geographic location may be compared to determine a comparison result. The mode of physical communication may be determined based on the comparison result.

For example, a fifth instruction set may determine a threshold distance parameter and/or calculate the distance between the predetermined geographic location and a specific geographic location associated with the selected user profile 208, and/or compare the threshold distance parameter and the calculated distance to determine a mode of physical communication based on the comparison.

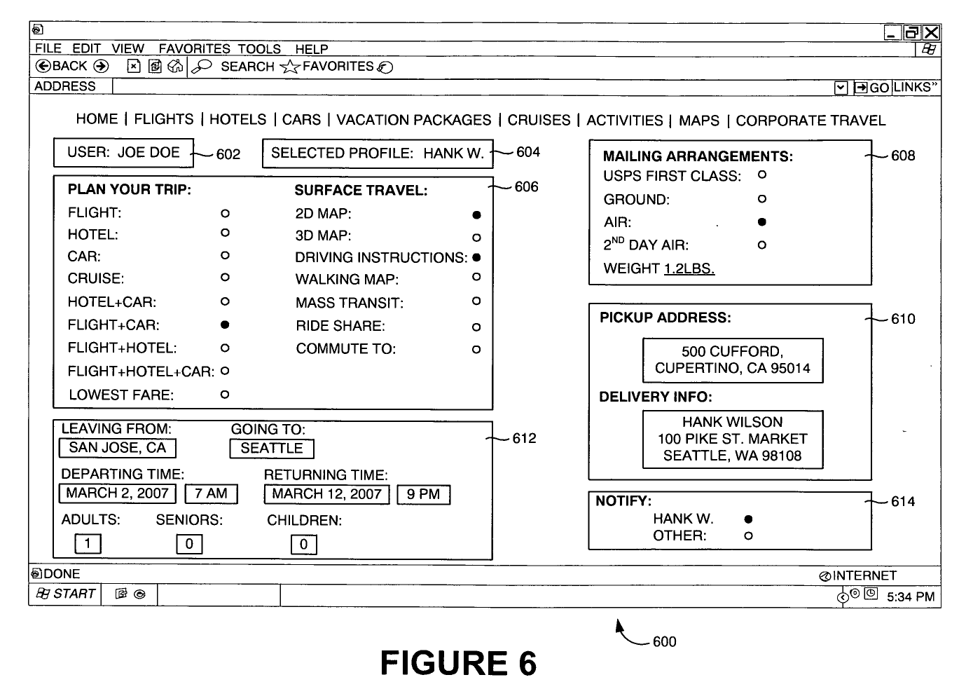

FIG. 6 is a mode determination view 600 for the user 102 associated with the first user profile 208 to travel using the buddy list, according to one embodiment. Particularly, FIG. 6 illustrates a user field 602, a selected profile 604, an option 606, a mail to option 608, a mailing label 610, an air label 612 and a notify option 614, according to one embodiment.

The user field 602 may display the name of the user 102 with whom the first user profile 208 is associated in the integrated geosocial environment 100. The selected profile 604 may display the selected people, businesses and/or places from the buddy list of the user 102. The option 606 may enable the user 102 to choose a particular travel mode (e.g., surface travel, air, car, etc.) to travel to the selected profile (e.g., a second user profile 208 in the integrated geosocial environment 100) from the buddy list. The option 608 may facilitate physical mailing to communicate letters, packages, messages relevant to a physical communication plan, and so forth, to people (e.g., users 102) involved in the physical communication plan.

The mailing label 610 may display the address information of the user 102 associated with the first user profile 208 and the second user profile 208 selected from the buddy list. The air label 612 may indicate the departing time, returning time and/or other details of the user 102 associated with the first profile while traveling to the selected profile from his/her buddy list. The notify option 614 may allow the user 102 associated with the first profile to inform users associated with selected profiles from the buddy list and/or other people about his/her travel or other information.

In the example embodiment illustrated in FIG. 6, the mode determination view 600 may display various modes of physical communication, e.g., travel and/or mail. The user may select various options to generate a physical communication plan for physical communication associated with a selected user profile 208. Also, the mode determination view 600 may allow the user 102 to notify the selected second user 208 of information regarding the physical communication (e.g., his/her travel plans, pickup address, delivery information, departing time and/or the returning time).

A plurality of modes of physical communication may be provided (e.g., between users 102 of the integrated geosocial environment 100). A mode of physical communication may be selected (e.g., a physical communication plan may be based on the selected mode of physical communication). In addition, physical communication options may be provided (e.g., based on the mode of physical communication) within the integrated geosocial environment 100.

A message relevant to the physical communication plan may be communicated to a recipient (e.g., a user 102). A sixth instruction set may provide options related to a mode of physical communication and/or may select an option of the options related to the mode of physical communication (e.g., the physical communication plan may be partially derived from the selected option related to the mode of physical communication).

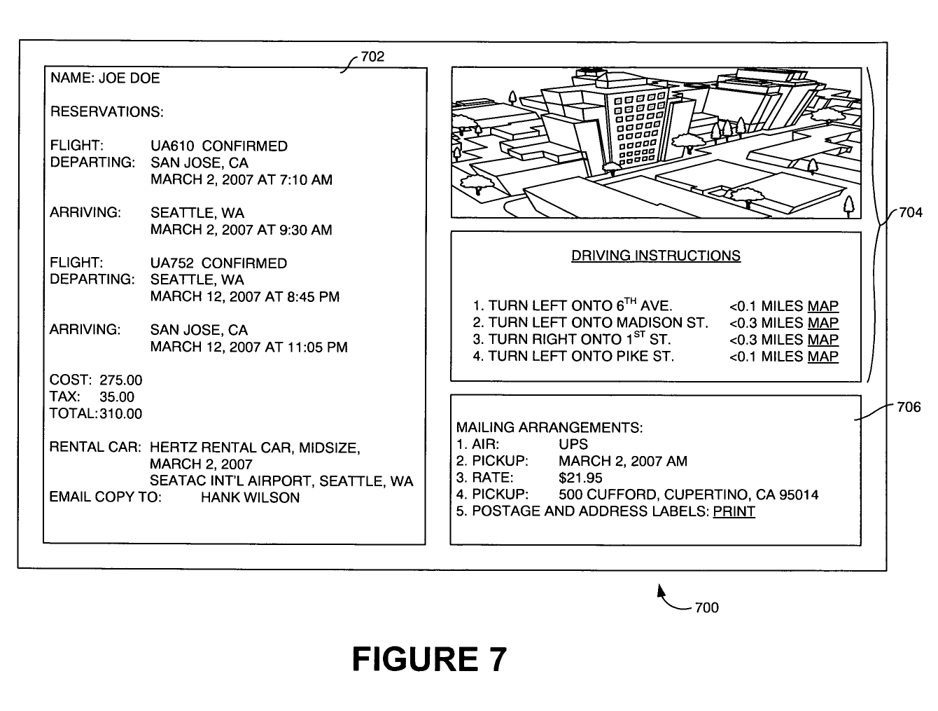

FIG. 7 is a physical communication plan 700 of the user 102 associated with the first user profile 208, according to one embodiment. Particularly, FIG. 7 illustrates a reservation chart 702, a map 704, and mailing arrangements 706, according to one embodiment.

The reservation chart 702 may show the final travel plan of the user 102 associated with the first user profile 208. The map 704 may provide driving directions to indicate geographic locations associated with the selected user profile 208 from the buddy list. The mailing arrangements 706 may show the details for scheduling a mail pickup.

In the example embodiment illustrated in FIG. 7, the physical communication plan may display the final physical communication arrangements (e.g., travel and mail arrangements) made by the user 102 associated with the first user profile 208 using the buddy list.

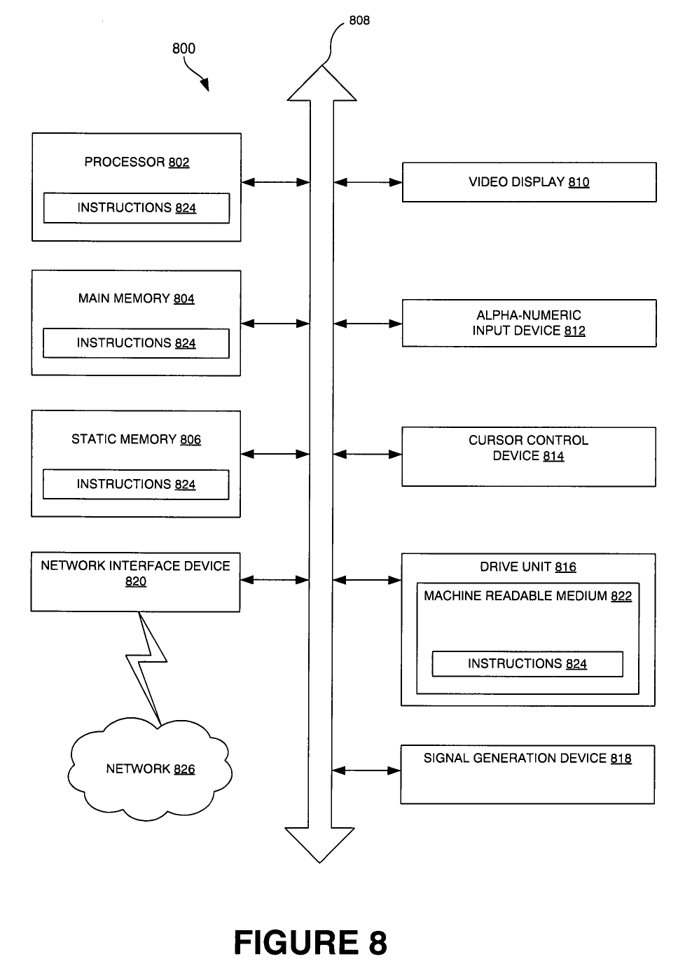

FIG. 8 is a diagrammatic system view 800 of a data processing system in which any of the embodiments disclosed herein may be performed, according to one embodiment. Particularly, the system view 800 of FIG. 8 illustrates a processor 802, a main memory 804, a static memory 806, a bus 808, a video display 810, an alpha-numeric input device 812, a cursor control device 814, a drive unit 816, a signal generation device 818, a network interface device 820, a machine readable medium 822, instructions 824, and a network 826, according to one embodiment.

The diagrammatic system view 800 may indicate a personal computer and/or a data processing system in which one or more operations disclosed herein may be performed. The processor 802 may be a microprocessor, a state machine, an application-specific integrated circuit, a field programmable gate array, etc. (e.g., Intel® Pentium® processor). The main memory 804 may be a dynamic random access memory and/or a primary memory of a computer system. The static memory 806 may be a hard drive, a flash drive, and/or other memory information associated with the data processing system.

The bus 808 may be an interconnection between various circuits and/or structures of the data processing system. The video display 810 may provide graphical representation of information on the data processing system. The alpha-numeric input device 812 may be a keypad, a keyboard and/or any other input device of text (e.g., a special device to aid the physically challenged). The cursor control device 814 may be a pointing device such as a mouse.

The drive unit 816 may be a hard drive, a storage system, and/or other longer term storage subsystem. The signal generation device 818 may be a bios and/or a functional operating system of the data processing system. The network interface device 820 may be a device that may perform interface functions such as code conversion, protocol conversion and/or buffering required for communication to and from a network. The machine readable medium 822 may provide instructions on which any of the methods disclosed herein may be performed. The instructions 824 may provide source code and/or data code to the processor 802 to enable any one/or more operations disclosed herein.

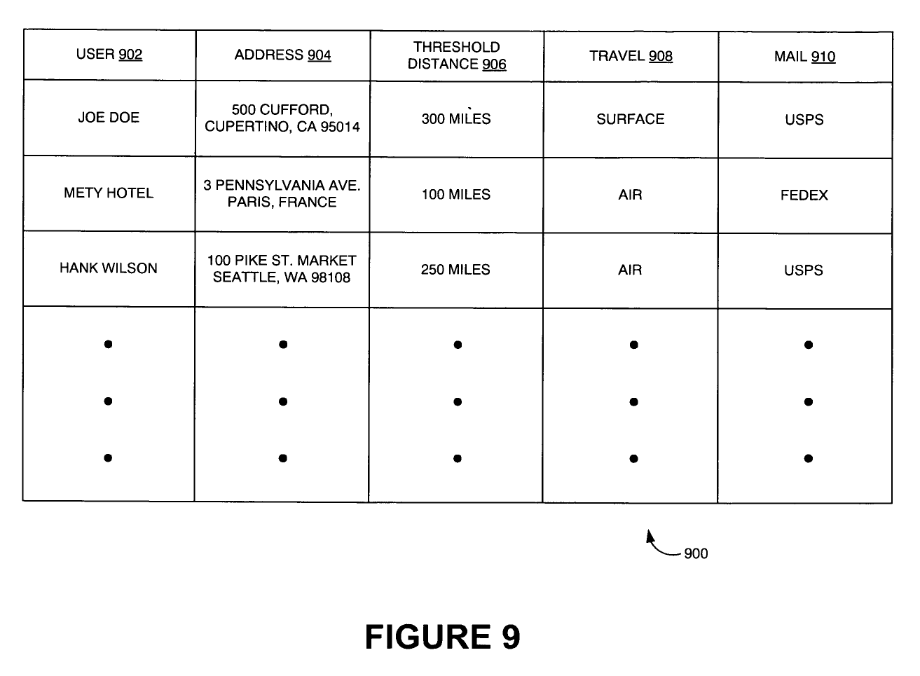

FIG. 9 is a table view 900 of a user 102 travel plan, according to one embodiment. Particularly, FIG. 9 illustrates a user field 902, an address field 904, a threshold distance field 906, a travel field 908 and a mail field 910, according to one embodiment.

The user field 902 may display the name of the users 102 associated with the user profiles 208 in the integrated geosocial environment 100. The address field 904 may display the details of the geographic location associated with the user profiles 208 in the integrated geosocial environment 100. The threshold distance field 906 may indicate the maximum distance the user 102 may wish to travel by a specific mode (e.g., surface travel) to the selected profile in the buddy list. The travel field 908 may display the travel mode chosen by the user 102 to travel based on the distance between the user 102 and the destination point. The mail field 910 may indicate the type of correspondence or service used to communicate messages relevant to the travel arrangements of the user 102 in the integrated geosocial environment 100.

In the example embodiment illustrated in FIG. 9, the user field 902 displays “Joe Doe” in the first row, “Mety Hotel” in the second row and “Hank Wilson” in the third row of the user field column 902. The address field 904 displays “500 Cufford, Cupertino, Calif. 95014” in the first row, “3 Pennsylvania Ave. Paris, France” in the second row and “100 Pike St. Market, Seattle, Wash. 98108” in the third row of the address field column 904. The threshold distance field 906 may display “300 miles” in the first row, “100 miles” in the second row and “250 miles” in the third row of the threshold distance second row and “Air” in the third row of the travel field column 908. The mail field 910 may display “USPS” in the first row, “FedEx” in the second row and “USPS” in the third row of the mail field column 910.

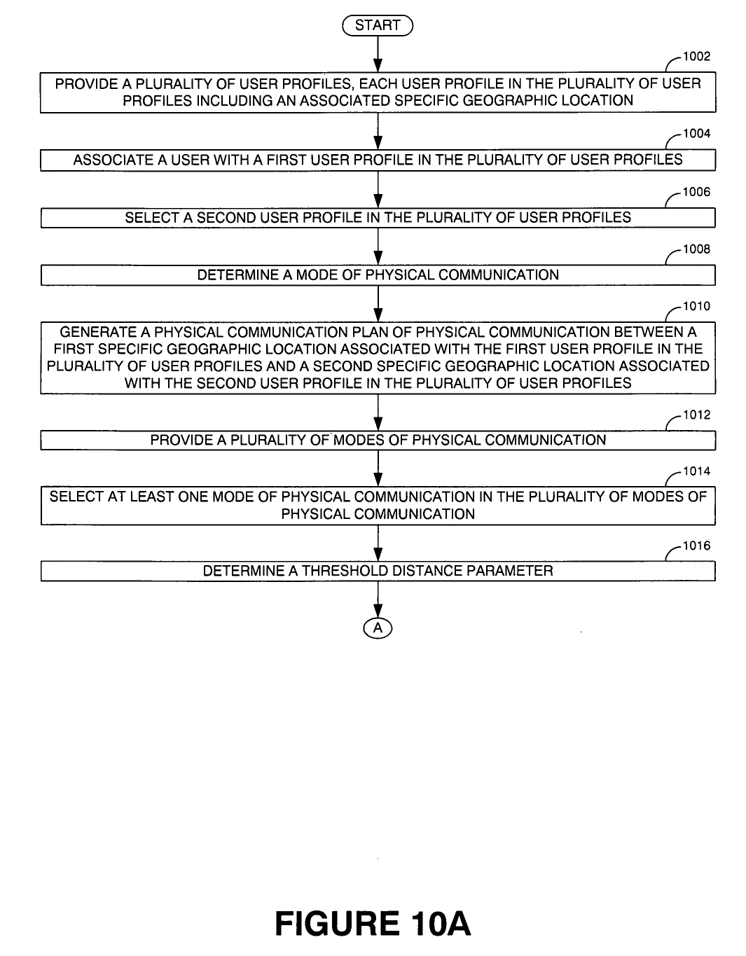

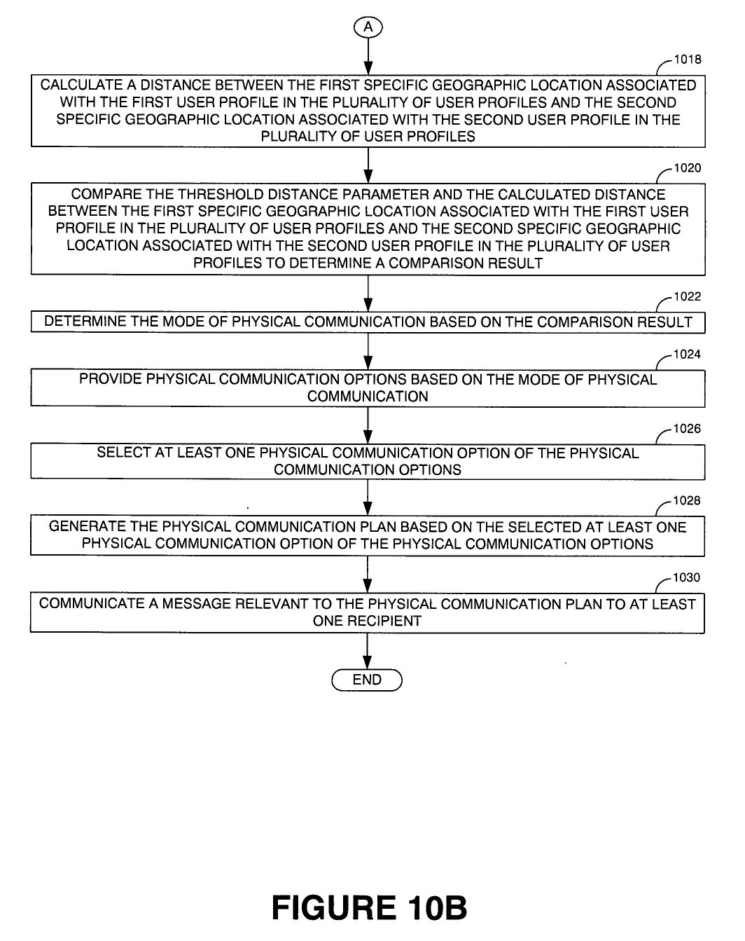

FIG. 10A is a process flow of generating a physical communication plan in an integrated geosocial environment (e.g., the integrated geosocial environment 100 of FIG. 1), according to one embodiment. In operation 1002, any number of user profiles 208, each user profile 208 to include an associated specific geographic location, may be provided. In operation 1004, a user (e.g., the users 102 of FIG. 1) may be associated with a first user profile (e.g., the user profile 208 of FIG. 2) in the any number of user profiles 208. In operation 1006, a second user profile 208 may be selected in the any number of user profiles 208. In operation 1008, a mode of physical communication (e.g., travel by air, by surface, by rail, by public transport and/or delivery by postal mail, by courier, etc.) may be determined.

In operation 1010, a physical communication plan may be generated of physical communication between a first specific geographic location associated with the first user profile 208 and a second specific geographic location associated with the second user profile 208. In operation 1012, a plurality of modes of physical communication may be provided (e.g., using the mode determination module 112 of FIG. 1). In operation 1014, at least one mode of physical communication (e.g., travel, in the plurality of modes of physical communication may be selected. In operation 1016, a threshold distance parameter (e.g., for a distance between two specific geographic locations in the integrated geosocial environment 100) may be determined.

FIG. 10B is a continuation of the process flow of FIG. 10A illustrating additional processes, according to one embodiment. In operation 1018, a distance between the first specific geographic location associated with the first user profile 208 in the plurality of user profiles 208 and the second specific geographic location associated with the second user profile 208 in the plurality of user profiles 208 may be calculated. In operation 1020, the threshold distance parameter and the calculated distance between the first specific geographic location associated with the first user profile 208 and the second specific geographic location associated with the second user profile 208 may be compared to determine a comparison result.

In operation 1022, the mode of physical communication may be determined based on the comparison result. In operation 1024, physical communication options may be provided based on the mode of physical communication. In operation 1026, at least one physical communication option may be selected. In operation 1028, the physical communication plan may be generated based on the selected physical communication option. In operation 1030, a message relevant to the physical communication plan may be communicated to a recipient (e.g., a user 102 of the integrated geosocial environment 100).

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application-specific integrated ASIC circuitry and/or in Digital Signal; Processor DSP circuitry). For example, the social network module 106, the map module 108, the selection module 110, the mode determination module 112, the plan module 114, the additional modules 116, the profile add module 302, the display module 304, the travel arrangement module 306, the mail module 308, the surface travel module 306A, the air travel module 306B, the rental car module 306C and the travel package module 306D of FIGS. 1-3 may be enabled using a social network circuit, a map circuit, a selection module circuit, a mode determination circuit, a plan circuit, a additional circuit, a profile add circuit, a display circuit, a travel arrangement circuit, a mail circuit, a surface travel circuit, a air travel circuit, a rental car circuit, and a travel package circuit using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method, comprising:
providing a plurality of user profiles, each user profile in the plurality of user profiles to include an associated specific geographic location;
associating a user with a first user profile in the plurality of user profiles;
selecting a second user profile in the plurality of user profiles;
determining a mode of physical communication; and
generating a physical communication plan of physical communication between a first specific geographic location associated with the first user profile in the plurality of user profiles and a second specific geographic location associated with the second user profile in the plurality of user profiles, wherein the physical communication plan is based on the determined mode of physical communication.

2. The method of claim 1, further comprising:
providing a plurality of modes of physical communication; and
selecting at least one mode of physical communication in the plurality of modes of physical communication, wherein the physical communication plan is based on the at least one mode of physical communication in the plurality of modes of physical communication.

3. The method of claim 1, further comprising:
determining a threshold distance parameter;
calculating a distance between the first specific geographic location associated with the first user profile in the plurality of user profiles and the second specific geographic location associated with the second user profile in the plurality of user profiles;
comparing the threshold distance parameter and the calculated distance between the first specific geographic location associated with the first user profile in the plurality of user profiles and the second specific geographic location associated with the second user profile in the plurality of user profiles to determine a comparison result; and
determining the mode of physical communication based on the comparison result.

4. The method of claim 1, further comprising:
providing physical communication options based on the mode of physical communication;
selecting at least one physical communication option of the physical communication options; and
generating the physical communication plan based on the selected at least one physical communication option of the physical communication options.

5. The method of claim 1, further comprising:
communicating a message relevant to the physical communication plan to at least one recipient.

6. The method of claim 1 in a form of a machine-readable medium embodying a set of instructions that, when executed by a machine, causes the machine to perform the method of claim 1.

7. A system, comprising:
an integrated geosocial environment;
a social network module of the integrated geosocial environment, the social network module to include user profiles, each user profile of the user profiles to include an associated specific geographic location;
a map module to include map data of the specific geographic locations of each user profile of the user profiles, the map data to serve as a basis to determine physical communication plans and to render maps modeling at least two orthogonal directions to indicate at least one specific geographic location associated with a selected user profile of the user profiles;
a selection module to select a second user profile of the user profiles;
a mode determination module to determine a mode of physical communication; and
a plan module to generate a physical communication plan to detail a physical communication between a first specific geographic location associated with a first user profile and a second specific geographic location associated with the second user profile.

8. The system of claim 7, further comprising:
a profile add module to add a user profile to the user profiles and to modify the user profile of the user profiles.

9. The system of claim 7, further comprising:
a display module to display a plurality of modes of physical communication associated with the second user profile and to select at least one mode of physical communication in the plurality of modes of physical communication associated with the second user profile.

10. The system of claim 7, further comprising:
a travel arrangement module to include travel planning data to use as a basis to generate the physical communication plan.

11. The system of claim 10, further comprising:
a surface travel module to include route data to use as a basis to generate surface travel instructions included in the physical communication plan.

12. The system of claim 10, further comprising:
an air travel module to include air travel data to use as a basis to generate an air travel itinerary and reservations included in the physical communication plan.

13. The system of claim 10, further comprising:
a rental car module to include rental car data to use as a basis to generate a rental car reservation included in the physical communication plan.

14. The system of claim 10, further comprising:
a travel package module to include data related to combined modes of transportation to use as a basis to generate a travel package included in the physical communication plan.

15. The system of claim 7, further comprising:
a mail module to include mail data to use as a basis to generate printable postage labels and printable address labels included in the physical communication plan.

16. An integrated geosocial environment, comprising:
a first instruction set to enable a social network, to include a people database, a businesses database, and a places database, each of the people database, the businesses database, and the places database to include associated user profiles, the social network associated with global map data, in which the social network is associated with specific geographic locations identifiable in the global map data;
a second instruction set integrated with the first instruction set to select a user profile of the user profiles, the user profile to include an associated specific geographic location identifiable in the global map data; and
a third instruction set integrated with the first instruction set and the second instruction set to generate a physical communication plan between a predetermined geographic location and the specific geographic location associated with the selected user profile.

17. The integrated geosocial environment of claim 16, further comprising:
a fourth instruction set to provide a plurality of modes of physical communication and to determine at least one mode of physical communication of the plurality of modes of physical communication, wherein the physical communication plan is at least partially derived from the at least one mode of physical communication in the plurality of modes of physical communication.

18. The integrated geosocial environment of claim 16, further comprising:
a fifth instruction set to determine a threshold distance parameter and to calculate a distance between the predetermined geographic location and a specific geographic location associated with the selected user profile, and to compare the threshold distance parameter and the calculated distance to determine a mode of physical communication based on the comparison.

19. The integrated geosocial environment of claim 16, further comprising:
a sixth instruction set to provide options related to a mode of physical communication and to select at least one option of the options related to the mode of physical communication, wherein the physical communication plan is at least partially derived from the selected, at least one option of the options related to the mode of physical communication.

20. The integrated geosocial environment of claim 16, further comprising:
a seventh instruction set to provide information about the physical communication plan to at least one recipient.
